(19) United States
(12) Patent Application Publication
(10) Pub. No.: US 2009/0095168 A1
(43) Pub. Date: Apr. 16, 2009

(54) Broiler Pan having Grease Draining Function

(76) Inventor: Chi-Jang Shu, Fu-Hsing Town (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/242,985

(22) Filed: Oct. 1, 2008

(30) Foreign Application Priority Data
Oct. 12, 2007 (TW) 096217081

(51) Int. Cl. A47J 37/10

(52) U.S. Cl. 99/425

(57) ABSTRACT

A broiler pan includes a pan body having a surface provided with a screw bore, a grease draining pipe mounted on a bottom of the pan body and connected to the screw bore of the pan body, and a control screw releasably mounted in the screw bore of the pan body and rotatable relative to the pan body. Thus, the control screw is unscrewed from the screw bore of the pan body to connect the grease draining pipe to the screw bore of the pan body, so that the grease in the receiving chamber of the pan body in turn flows through the screw bore of the pan body into the grease draining pipe and is drained outwardly from the grease draining pipe.

### BACKGROUND OF THE INVENTION

1. Field of the Invention

The present invention relates to a broiler pan and, more particularly, to a broiler pan for cooking or broiling food, such as meat and the like.

2. Description of the Related Art

A conventional broiler pan in accordance with the prior art shown in FIGS. 7 and 8 comprises a pan body 20 having a peripheral wall provided with a stop wall 21. Thus, the pan body 20 is used to cook or broil food, such as meat and the like. However, when the grease in the pan body 20 is collected and accumulated to a determined amount, the grease cannot be drained easily, thereby causing inconvenience to the user.

### BRIEF SUMMARY OF THE INVENTION

In accordance with the present invention, there is provided a broiler pan, comprising a pan body having a surface provided with a screw bore, a grease draining pipe mounted on a bottom of the pan body and connected to the screw bore of the pan body, and a control screw releasably mounted in the screw bore of the pan body and rotatable relative to the pan body between a first position where the control screw is screwed into the screw bore of the pan body to interrupt a connection between the grease draining pipe and the screw bore of the pan body and a second position where the control screw is unscrewed from the screw bore of the pan body to connect the grease draining pipe to the screw bore of the pan body.

The primary objective of the present invention is to provide a broiler pan having grease draining function.

Another objective of the present invention is to provide a broiler pan, wherein the control screw is unscrewed from the screw bore of the pan body to connect the grease draining pipe to the screw bore of the pan body, so that the grease in the receiving chamber of the pan body in turn flows through the screw bore of the pan body into the grease draining pipe and is drained outwardly from the grease draining pipe, thereby facilitating a user draining the grease.

A further objective of the present invention is to provide a broiler pan, wherein after the grease is drained outwardly, the control screw is screwed into the screw bore of the pan body to interrupt the connection between the grease draining pipe and the screw bore of the pan body, and the O-ring provides an air-tight effect between the control screw and the screw bore of the pan body, so that the pan body is closed to facilitate the user cooking or broiling the food.

A further objective of the present invention is to provide a broiler pan, wherein the user only needs to rotate the control screw to close or open the pan body, thereby facilitating the user operating the broiler pan.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a broiler pan in accordance with the preferred embodiment of the present invention.

FIG. 2 is an exploded perspective view of the broiler pan as shown in FIG. 1.

FIG. 3 is a partially perspective cross-sectional view of a pan body of the broiler pan as shown in FIG. 2.

FIG. 4 is a bottom perspective view of the pan body of the broiler pan as shown in FIG. 2.

FIG. 5 is a front cross-sectional view of the broiler pan as shown in FIG. 1.

FIG. 6 is a schematic operational view of the broiler pan as shown in FIG. 5.

FIG. 7 is a perspective view of a conventional broiler pan in accordance with the prior art.

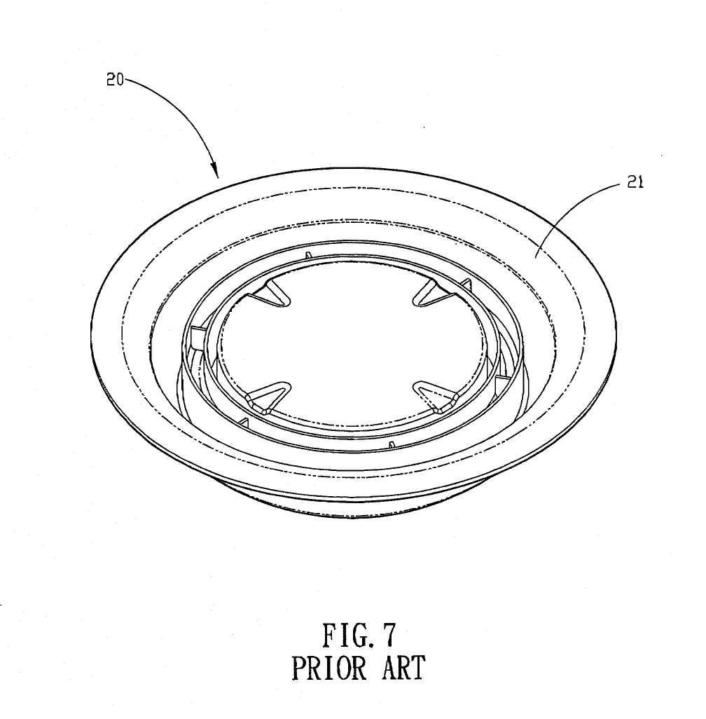

FIG. 8 is a front cross-sectional view of the conventional broiler pan as shown in FIG. 7.

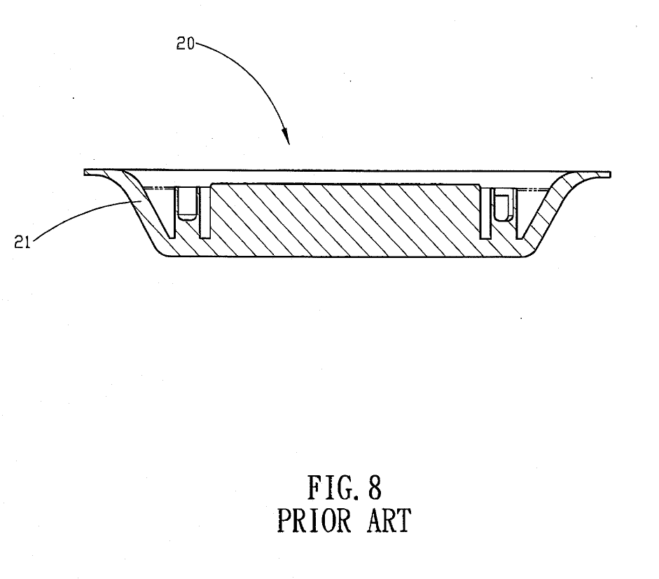

### DETAILED DESCRIPTION OF THE INVENTION

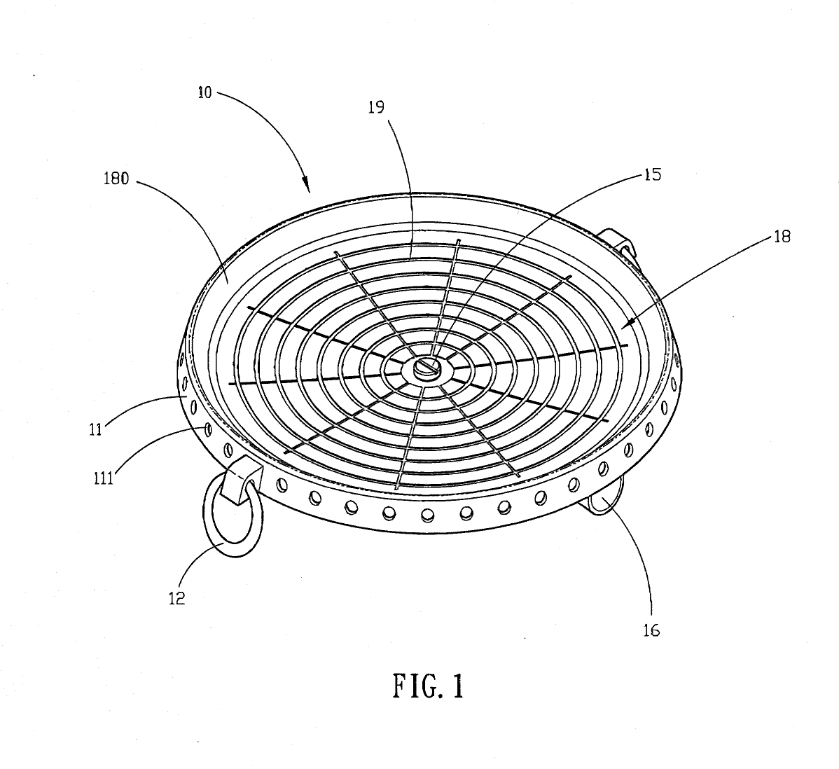

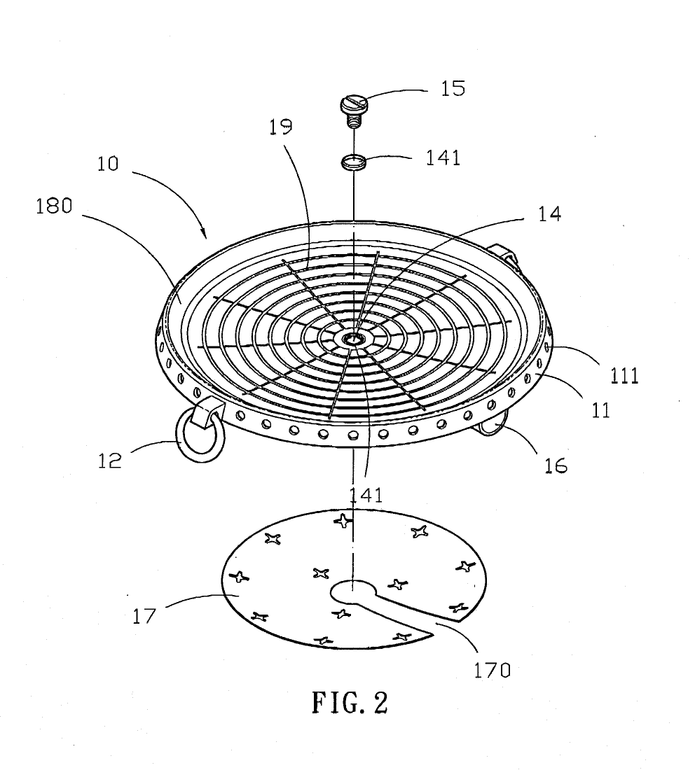

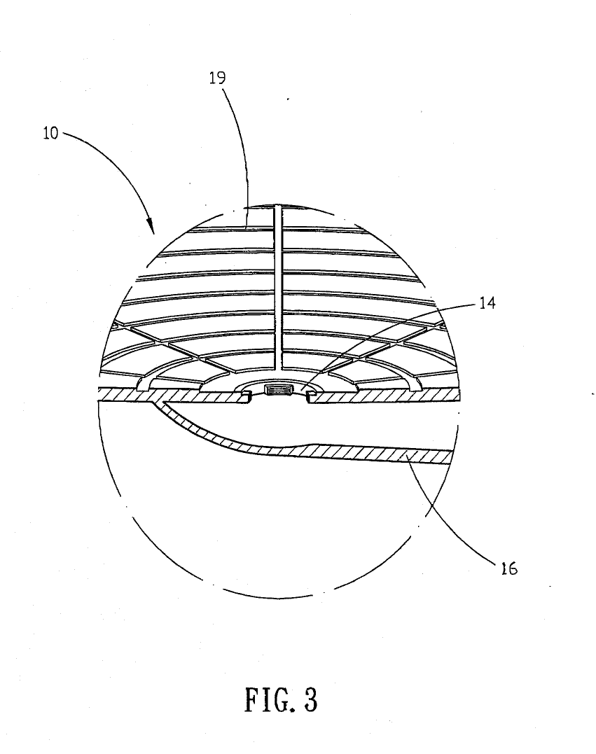

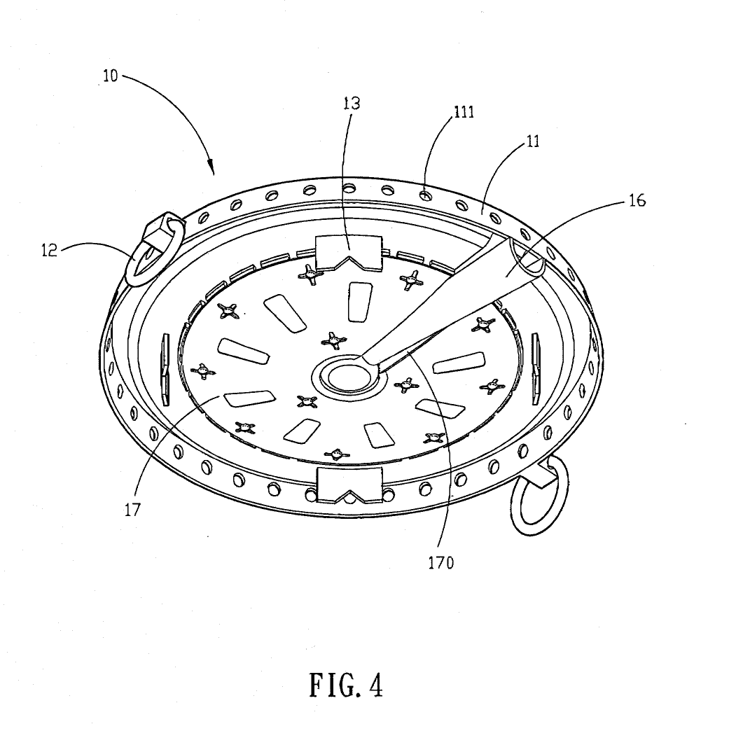

Referring to the drawings and initially to FIGS. 1-5, a broiler pan in accordance with the preferred embodiment of the present invention comprises a pan body 10 having a surface provided with a screw bore 14, a grease draining pipe 16 mounted on a bottom of the pan body 10 and connected to the screw bore 14 of the pan body 10, and a control screw 15 releasably mounted in the screw bore 14 of the pan body 10 and rotatable relative to the pan body between a first position where the control screw 15 is screwed into the screw bore 14 of the pan body 10 to interrupt a connection between the grease draining pipe 16 and the screw bore 14 of the pan body 10 and a second position where the control screw 15 is unscrewed from the screw bore 14 of the pan body 10 to connect the grease draining pipe 16 to the screw bore 14 of the pan body 10.

The pan body 10 has a disk shape. The pan body 10 has a top provided with a receiving chamber 18 connected to the screw bore 14. The top of the pan body 10 is further provided with a spider-shaped grid 19 located in the receiving chamber 18. The receiving chamber 18 of the pan body 10 has a periphery provided with a tapered guide wall 180. The screw bore 14 of the pan body 10 is located at a central portion of the pan body 10 and is connected between the receiving chamber 18 of the pan body 10 and the grease draining pipe 16. The pan body 10 has a periphery provided with an annular side frame 11. The side frame 11 of the pan body 10 extends downward from the periphery of the pan body 10 in an oblique manner and has a surface provided with a plurality of ventilating holes 111.

The grease draining pipe 16 has a first end extending from the bottom of the pan body 10 and a second end flush with the side frame 11 of the pan body 10.

The broiler pan further comprises an O-ring 141 mounted in the screw bore 14 of the pan body 10 and located between the control screw 15 and the screw bore 14 of the pan body 10 to provide an air-tight effect between the control screw 15 and the screw bore 14 of the pan body 10, two handles 12 mounted on two opposite sides of the pan body 10, a plurality of upright support legs 13 mounted on the bottom of the pan body 10, and a heat collection plate 17 mounted on the bottom of the pan body 10 to collect the heat on the pan body 10 easily and quickly. Each of the two handles 12 has a ring shape and is pivotally mounted on the pan body 10. The heat collection plate 17 is provided with an elongate passage 170 to allow passage of the grease draining pipe 16. The heat collection plate 17 is located between the support legs 13.

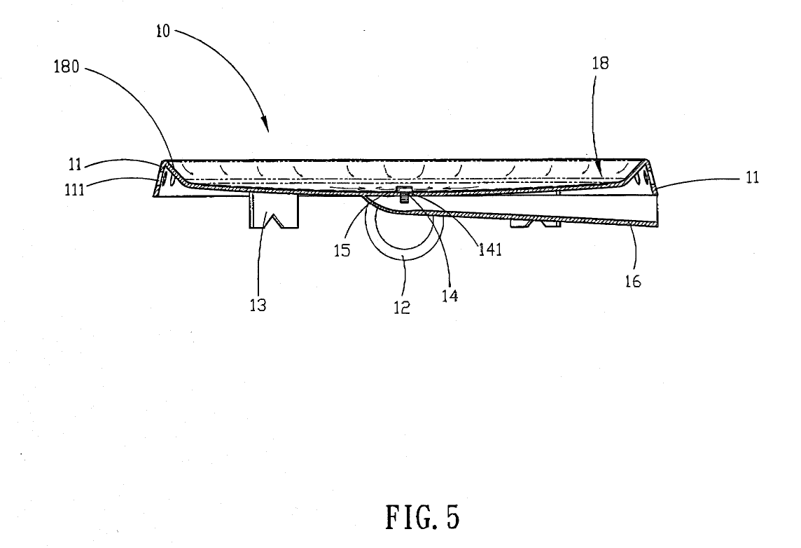

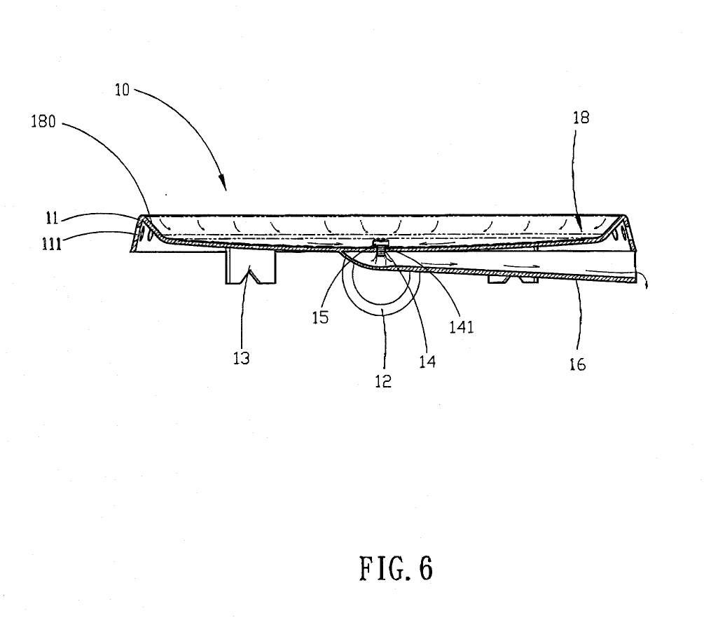

In operation, referring to FIGS. 5 and 6 with reference to FIGS. 1-4, the control screw 15 is screwed into the screw bore 14 of the pan body 10 as shown in FIG. 5 to interrupt the connection between the grease draining pipe 16 and the screw bore 14 of the pan body 10, and the O-ring 141 provides an air-tight effect between the control screw 15 and the screw bore 14 of the pan body 10, so that the pan body 10 is closed to cook or broil food, such as meat and the like. On the contrary, when the grease in the receiving chamber 18 of the pan body 10 is collected and accumulated to a determined amount, the control screw 15 is unscrewed from the screw bore 14 of the pan body 10 as shown in FIG. 6 to connect the grease draining pipe 16 to the screw bore 14 of the pan body 10, so that the grease in the receiving chamber 18 of the pan body 10 in turn flows through the screw bore 14 of the pan body 10 into the grease draining pipe 16 and is drained outwardly from the grease draining pipe 16.

Accordingly, the control screw 15 is unscrewed from the screw bore 14 of the pan body 10 to connect the grease draining pipe 16 to the screw bore 14 of the pan body 10, so that the grease in the receiving chamber 18 of the pan body 10 in turn flows through the screw bore 14 of the pan body 10 into the grease draining pipe 16 and is drained outwardly from the grease draining pipe 16, thereby facilitating a user draining the grease. In addition, after the grease is drained outwardly, the control screw 15 is screwed into the screw bore 14 of the pan body 10 to interrupt the connection between the grease draining pipe 16 and the screw bore 14 of the pan body 10, and the O-ring 141 provides an air-tight effect between the control screw 15 and the screw bore 14 of the pan body 10, so that the pan body 10 is closed to facilitate the user cooking or broiling the food. Further, the user only needs to rotate the control screw 15 to close or open the pan body 10, thereby facilitating the user operating the broiler pan.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A broiler pan, comprising:
a pan body having a surface provided with a screw bore;
a grease draining pipe mounted on a bottom of the pan body and connected to the screw bore of the pan body;
a control screw releasably mounted in the screw bore of the pan body and rotatable relative to the pan body between a first position where the control screw is screwed into the screw bore of the pan body to interrupt a connection between the grease draining pipe and the screw bore of the pan body and a second position where the control screw is unscrewed from the screw bore of the pan body to connect the grease draining pipe to the screw bore of the pan body.

2. The broiler pan of claim 1, wherein the pan body has a periphery provided with an annular side frame.

3. The broiler pan of claim 2, wherein the side frame of the pan body has a surface provided with a plurality of ventilating holes.

4. The broiler pan of claim 1, further comprising:
an O-ring mounted in the screw bore of the pan body and located between the control screw and the screw bore of the pan body to provide an air-tight effect between the control screw and the screw bore of the pan body.

5. The broiler pan of claim 1, further comprising:
two handles mounted on two opposite sides of the pan body.

6. The broiler pan of claim 1, further comprising:
a plurality of upright support legs mounted on the bottom of the pan body.

7. The broiler pan of claim 6, further comprising:
a heat collection plate mounted on the bottom of the pan body to collect the heat on the pan body easily and quickly.

8. The broiler pan of claim 1, wherein the pan body has a top provided with a receiving chamber connected to the screw bore.

9. The broiler pan of claim 8, wherein the top of the pan body is further provided with a spider-shaped grid located in the receiving chamber.

10. The broiler pan of claim 8, wherein the receiving chamber of the pan body has a periphery provided with a tapered guide wall.

11. The broiler pan of claim 1, wherein the screw bore of the pan body is located at a central portion of the pan body.

12. The broiler pan of claim 8, wherein the screw bore of the pan body is connected between the receiving chamber of the pan body and the grease draining pipe.

13. The broiler pan of claim 2, wherein the side frame of the pan body extends downward from the periphery of the pan body in an oblique manner.

14. The broiler pan of claim 2, wherein the grease draining pipe has a first end extending from the bottom of the pan body and a second end flush with the side frame of the pan body.

15. The broiler pan of claim 5, wherein each of the two handles has a ring shape.

16. The broiler pan of claim 5, wherein each of the two handles is pivotally mounted on the pan body.

17. The broiler pan of claim 7, wherein the heat collection plate is provided with an elongate passage to allow passage of the grease draining pipe.

18. The broiler pan of claim 7, wherein the heat collection plate is located between the support legs.

19. The broiler pan of claim 1, wherein the pan body has a disk shape.
